(19) United States
(12) Patent Application Publication
(10) Pub. No.: US 2008/0164984 A1
(43) Pub. Date: Jul. 10, 2008

(54) Security System for Vehicles, Trucks and Shipping Containers

(76) Inventor: Eliezer Sheffer, Petach Tikva (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/720,518

(22) PCT Filed: Dec. 18, 2005
(86) PCT No.: PCT/IL05/01357

§ 371 Date: May 31, 2007

Related U.S. Application Data
(60) Provisional application No. 60/636,491, filed on Dec. 17, 2004.

(51) Int. Cl. B60R 25/10

(52) U.S. Cl. 340/426.13

(57) ABSTRACT

A method which protects mobile entities typically shipping containers (111) and vehicles Wireless transceivers (101, 105), preferably with sensors attached, are installed on the entities and a master transceiver and a master transceiver is periodically selected from among the wireless transceivers The master transceiver communicates with at least some of the wireless transceivers which form a cluster (21) Positive status information from each of the wireless transceivers of the cluster (21) is continuously transferred to the master transceiver A communications tamper on one or more of the wireless transceivers is suspected and the master transceivers performs an alert when the positive status information is not received from one or more other transceivers of the cluster (21)

### FIELD AND BACKGROUND OF THE INVENTION

The present invention relates to a system and method for securing shipping containers, ships and trucks particularly world-wide or over a wide area. Specifically, the method is resistant to communications tampers, provides alerts in real time using existing worldwide wireless infrastructure.

The Container Security Initiative (CSI) was launched in 2002 by the U.S. Bureau of Customs and Border Protection (CBP), an agency of the U.S. Department of Homeland Security. The purpose of CSI is to increase security for container cargo shipped to the United States. The intent is to “extend the zone of security outward so that American borders are the last line of defense, not the first.”

Containerized shipping is a critical component of international trade. According to the CBP, about 90% of the world's trade is transported in cargo containers, almost half of incoming U.S. trade (by value) arrives by containers on-board ships and nearly seven million cargo containers arrive on ships and are offloaded at U.S. seaports each year.

As terrorist organizations have increasingly turned to destroying economic infrastructure to threaten nations, the vulnerability of international shipping has come under scrutiny. Under the CSI program, screening of containers that pose a risk for terrorism is accomplished by teams of CBP officials deployed to work in concert with their host nation counterparts.
(Ref: http://en.wikipedia.org/wiki/Container_Security_Initiative)

There is considerable prior art in the area of securing cargo in transit. A representative prior art reference is US patent application publication 2005/0248454 entitled “Marine Asset Security and Tracking System” as disclosed by Hanson et. al. Hanson et. al disclose a system using radio frequency identification (RFID) tags installed on containers. Multiple RFID readers are required, e.g. on ship, which relay information from the RFID tags to a site server installed on ship or in port. The site server relays information regarding the monitored containers via satellite link to a network operations center. The disclosure of Hanson et. al, requires a considerable amount of infrastructure in order to operate, in particular the installation of RFID readers and site servers both on ship and in port. The presence of such infrastructure not only represents a considerable cost, but the infrastructure is readily susceptible to a security breach. RFID readers in the neighborhood of the containers which are being secured are susceptible to a communications tamper by jamming, powering down or otherwise removing temporarily from service. Similarly, it is relatively easy to tamper with the communications of a local satellite link, for a short period of time, and during that time introduce a hazardous material into a container and then restore communications to the local satellite link.

Another disadvantage using prior art RFID systems to employ a worldwide network is the lack of global standardization of RFID systems.

Another representative prior art reference in the area of securing cargo containers is US patent publication 2005025229 entitled “Method and system for monitoring containers to maintain the security thereof” as disclosed by Ekstrom. US patent publication 2005025229 discloses a sensor that senses a distance or an angle value between a door of the container and a frame of the container and the sensed value is then transmitted to a device. The device obtains a baseline value that is related to a calculated mean value. The device also obtains a detection threshold. The device determines if a security condition has occurred based on the sensed value and the detection threshold, and if a security condition has occurred the device communicates with a reader. US patent publication 2005025229 discloses a method known in the security field as “exception reporting”, where an “exception” in generated by a locally sensed value, e.g. door angle, deviating from an acceptable value. There are several reasons for the prevalence of “exception reporting” in security systems. The use of “exception reporting”, as opposed to continuous reporting the state of all containers, minimizes the number of open communications sessions required in the security system. If a security system relies on a satellite communications network, the communications cost of continuous reporting is exorbitant. Another reason for the prevalence of security systems using exception reporting is related to power management. Typically, transceivers, used in cargo security systems are battery powered, (e.g. active RFID tag) and continuous reporting rapidly drains the battery powering the transceiver. Consequently, modern security systems typically rely on “exception reporting” although they are susceptible to a communications tamper, e.g. jamming the transmissions, damaging of the antenna prior to breaching the container.

Geo-fencing is a term used for systems which track the global position of vehicles, and an alert is provided if the position of the vehicle varies out of a predetermined region or route. Current geo-fencing systems require complex logistical expense involved in programming the pre-determined route. In US patent application publication 20050159883, entitled, “Method and system for tracked device location and route adherence via geo-fencing”, as disclosed by Humphries, Laymon Scott et al., a tracked device receives a set of coordinates associated with a boundary area and obtains a position of the tracked device. Based upon the received coordinates and the detected position of the tracked device, a determination is made as to whether the tracked device is located inside the boundary area or outside the boundary area. An alert signal is then generated and transmitted if the result of the determination is different from an immediately previous obtained result. The disclosure of US patent application publication 20050159883 is a method which uses “exception reporting” in a geo-fencing system to reduce communications traffic to a fleet of vehicles. However, as in other cases of “exception reporting”, a truck secured according to the disclosure of 20050159883 is subject to be easily hijacked without detection by performing a communications tamper prior to driving the truck out of the previously determined region.

There is thus a need for, and it would be highly advantageous to have a system and method of globally securing containers and vehicles which is much less susceptible to communications tamper than prior art systems. Similarly, there is a need for a system for geo-fencing which is more easily managed than prior art geo-fencing systems.

Bluetooth™ is a radio standard primarily designed for low power consumption, with a power dependent range: ten to hundred meters with a low-cost transceiver microchip in each device. A Bluetooth device playing the role of the “master” can communicate with up to 7 devices playing the role of the “slave”. A network of up to eight devices, one master and seven slaves, is called a piconet. At any given time, data can be transferred between the master and one slave; but the master switches rapidly from slave to slave in a round-robin fashion. Either device may switch the master/slave role at any time. Bluetooth specification allows connecting two or more piconets together to form a scatternet, with some devices acting as a bridge by simultaneously playing the master role in one piconet and the slave role in another piconet.

### References:

http://en.wikipedia.org/wiki/BlueTooth,
http://en.wikipedia.org/wiki/BlueTooth™Specifications_and_Features)
More information regarding Bluetooth architecture is found in an article, “Bluetooth Architecture Overview” by James Kardach, published in Intel Technology Journal, Q2 2000, included herein by reference for all purposes is if entirely set forth herein and information regarding Bluetooth scatternet formation is found in an article, “Routing Strategy for Bluetooth Scatternet”, by Christophe Lafon, and Tariq S. Durrani, included herein by reference for all purposes as if entirely set forth herein.

The term “entity” or “mobile entity” refers to an asset, typically a mobile asset including vehicles and cargo containers. The term “vehicle” as used herein includes ships, trucks, automobiles, and airplanes. The term “continuous” or “continuously” as used herein refers to monitoring, reporting or transferring data at regular or irregular intervals at sufficient average frequency to minimize the possibility of a communications tamper to go undetected. The term “positive status information” as used herein refers to transmitted data which indicates normal status of a remote device or transceiver.

### SUMMARY OF THE INVENTION

According to the present invention there is provided a system which protects mobile entities. The entities include vehicles and containers. The system includes a sub-cluster of remote devices with one or more of the remote devices attached to each entity. Each remote device includes a long range transceiver which communicates with an external wireless connection and a short range transceiver which communicates with other remote devices of the sub-cluster. One of the remote devices is periodically selected as one of a master remote device of the sub-cluster; and the other remote devices of the cluster continuously transfer data to the master remote device using the short range transceiver. Preferably, the master remote device transmits an alert using the long range transceiver upon not receiving the data from one or more of the other remote devices. Preferably the external wireless connection includes a satellite communications connection. Preferably each remote device further includes an interface to one or more environmental sensors. Preferably, each remote device further includes a global positioning satellite receiver and wherein the data includes geographical coordinates of each remote unit received by the global positioning satellite receiver. Preferably, the system further includes a cluster of remote devices, and the cluster including the sub-cluster, and the master remote device transmits an alert to one of the remote devices selected as cluster leader of the cluster when the data is not received. Preferably the cluster leader is selected based on a received signal strength of the external wireless connection. Preferably, cluster leader is selected based on battery power availability. Preferably, the cluster leader is re-selected periodically at intervals of less than one minute. Preferably, solely said cluster leader transmits using said long range transceiver.

According to the present invention there is provided a method for securing a plurality of mobile entities, wherein the entities include vehicles, and containers. In the method remote devices are attached to the entities. The remote devices each include a long-range transceiver which communicates with an external wireless connection and a short-range transceiver which communicates with other remote devices. The remote devices are grouped into sub-clusters and the grouping includes selecting a master remote device from among the remote devices. Data is continuously transferred from the remote devices to the master remote device using the short range transceiver. Preferable, an alert is performed using the external wireless connection when the data is not received from one or more of the remote devices. Preferably, the grouping further includes grouping the sub-clusters into one or more clusters cluster, and upon not receiving the data from at least one of the remote devices, alerting a cluster leader using the short range transceiver, wherein the cluster leader is selected from among the remote devices. Preferably, the cluster leader alerts a control center using the external wireless connection. Preferably, the control center back queries one or more of the remote devices. Preferably, the grouping and the data transfer are performed periodically during an interval of less than one minute. Preferably the remote devices each include a mechanism for adjusting a range of the short-range receiver, and the grouping is performed at a shorter range prior to performing the grouping at a longer range. Preferably, the data transfer is performed upon query from the master remote device.

According to the present invention there is provided a method for geo-fencing a mobile entities. The entities include vehicles, and containers. In the method remote devices are attached to the entities. The remote devices each include a long-range transceiver which communicates with an external wireless connection, a short-range transceiver which communicates with other remote devices and a global positioning satellite receiver which receives local geographical coordinates. The remote devices are grouped into a cluster. The grouping includes selecting a cluster leader from among the remote devices. A data transfer is attempted from each of the remote devices to the cluster leader using the short range transceiver, the data including the respective geographical coordinates. The cluster leader alerts using the long range transceiver, either based on the received geographical coordinates, when the received geographical coordinates are outside previously defined limits or when the data from a remote device is not received.

According to the present invention there is provided a method which protects a plurality of entities. Wireless transceivers are attached to the entities and a master transceiver is periodically selected from among the wireless transceivers. The master transceiver communicates with at least some of the wireless transceivers which form a cluster. Positive status information from each of the wireless transceivers of the cluster is continuously transferred to the master transceiver. A communications tamper on one or more of the wireless transceivers is suspected and the master transceivers performs an alert when the positive status information is not received from one or more other transceivers of the cluster. Preferably, the periodic selection as master transceiver is based on either an amount of battery power stored in the master transceiver, and/or a received single strength to an external wireless connection to the master transceiver.

### BRIEF DESCRIPTION OF THE DRAWINGS

The invention is herein described, by way of example only, with reference to the accompanying drawings, wherein:

FIG. 1a is a simplified block diagram of a remote unit, according to an embodiment of the present invention;

FIG. 1b illustrates the remote unit mounted on a cargo container, according to an embodiment of the present invention.

FIG. 2 is a drawing according to an embodiment of the present invention of sub-cluster and cluster formation, according to an embodiment of the present invention;

FIG. 3 is a flow diagram, according to an embodiment of the present invention; and

FIG. 4 is a timing diagram illustrating timing of cluster and sub-cluster formation and data transfer, according to an embodiment of the present invention.

### DESCRIPTION OF THE PREFERRED EMBODIMENTS

The present invention is of a system and method of globally tracking and securing cargo containers and vehicles used in cargo transport such as ships and trucks. The system requires no support infrastructure, e.g. RFID readers, or equipment additional to an existing worldwide wireless infrastructure, e.g. low Earth orbit LEO satellite, and the method includes continuous reporting of the status of the secured vehicles. The continuous reporting virtually eliminates the possibility of a security breach by a communications tamper. The system, of the present invention, nevertheless conserves and manages battery power and only minimal communications with the global network, e.g. LEO, is required.

The principles and operation of a system and method of globally securing vehicles and containers, according to the present invention, may be better understood with reference to the drawings and the accompanying description.

It should be noted, that although the discussion herein relates to security systems of mobile entities, e.g. trucks, ships and containers, the present invention may, by non-limiting example, alternatively be configured as well for fixed entities, e.g. homes, hangars, airline terminals, military installations and factories.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, a principal intention of the present invention is to provide security to mobile entities, e.g. trucks, ships and containers by continuously monitoring, e.g. once/minute or less, each entity and by not relying primarily on exception reporting. In this way, a security breach by communications tampering is essentially eliminated. Another intention of the present invention is provide the continuous monitoring of the mobile entities without requiring infrastructure other than a single battery powered wireless device attached to each container. The method is such that batteries will not require replacement for a considerable period of time, e.g. one year. Another intention of the present invention is to provide continuous monitoring with minimal global, e.g. satellite communications requirements. Another intention of the present invention is to provide a system and method for geo-fencing by continuously monitoring location of mobile entities with minimal global communications requirements, and eliminating the logistical complexity of individually “programming” in real time the permitted locations and routes of each mobile entity prior to each leg of a trip.

Embodiments of the present invention are intended to provide radio coverage from “Door to Door” from the moment the container is loaded at originator's dock, to a final destination. A typical trip of a cargo container includes seven legs: originator's dock, port of embarkation, ocean voyage, destination port, overland trip, truck stops and destination dock. Embodiments of the present invention provide continuous monitoring status and location of each container. Status is based on remote device and sensors connected to the remote device, and location is determined by a GPS receiver. Additionally, false alarms are reduced since device and sensors status is typically checked continuously for any possible failure mode. In embodiments of the present invention communications link tampers are detected, thus eliminating the possibility of an undetected tamper by detecting any attempt to neutralize the communication link between the remote device and monitoring center.

The wireless battery powered device, according to embodiments of the present invention, is typically attached to one or more sensors, e.g. temperature, light, radiation, motion. The sensory mechanisms may be of any such mechanisms known in the art.

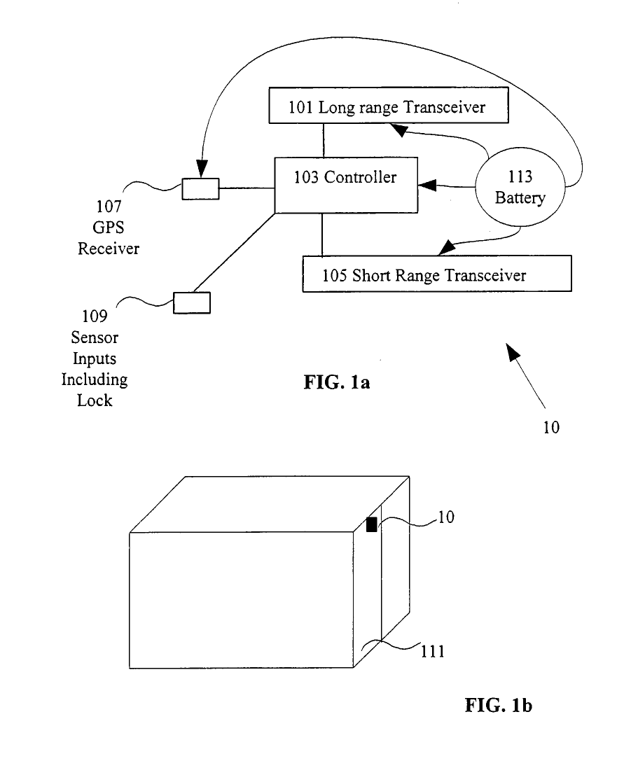

Referring now to the drawings, FIG. 1a illustrates a simplified block diagram of a remote unit 10 and FIG. 1b illustrates remote unit 10 attached to a cargo container 111. There is no restriction on the location of remote unit 10 as installed on cargo container 111. The location is typically based on considerations such as radio frequency transmission and space availability on the outside or inside of container 111. Remote unit 10 includes sensor input interface 109. Sensor inputs 109 are input to a controller 103 using wireless or wired connections. Sensor inputs 109 are preferably simple, e.g. dry-contact and non-proprietary and as new sensors are developed and marketed they may be easily incorporated into systems according to embodiments of the present invention. Controller 103 is a dedicated microprocessor or ASIC designed for low power consumption. Controller 103 manages communications between the various blocks, synchronizes events, receives/transmits data and commands, and turns modules on or off as required to conserve power. Long-range transceiver (LRT) 101 transmits status data, for instance via a satellite link if necessary. LRT 101 may be used to receive queries from and transfer data to a control center over a long range wireless connection. Short-range transceiver (SRT) 105 is designed to receive and transmit data from other remote units 10 in an immediate vicinity, e.g. up to 100 meters. Short Range Transceiver (SRT) 105 is designed to operate in a harsh RF environment, for instance in the presence of stacked multi-decked cargo containers which strongly attenuate RF transmission. Preferably, SRT 105 is configurable with gain control or switch to operate with low power over a very short range, e.g. ten meters or with higher power over a longer range, e.g. 100 meters. For instance, communications is first attempted at low power to establish communications with the nearest remote units 10 and only if there is insufficient response from other remote units 10 is the power increased. Remote unit 10 preferably includes a GPS receiver 107, attached to controller 103 to provide continuously geographical coordinates of the present location of remote unit 10. Power to all components of remote unit 10 is supplied by a battery 113.

Remote unit 10 is typically an integrated device including an electronic lock, sensors and battery. Battery 113 of remote unit 10 is preferable reusable, and recharged every several months. The integrated remote unit 10 is preferably manufactured to withstand harsh environment of extreme temperatures, shocks and vibrations, humidity, salt water, etc. It is assumed that the remote unit 10 may be mounted outside the container (with or without an integrated sensor), or remote unit 10 is mounted inside container 111 with external sensors connected by wire or wireless connection. When remote unit 10 is mounted outside container 111, remote unit 10 has to fit the dimensions of the door niche of container 111, so that even if another container 111 is placed flush against the door, remote unit 10 will not be damaged and will continue to operate. Other than the mechanical part of the lock, all other components of remote unit 10 are compartmentalized for RF isolation of transceivers 101 and 105, and for battery 113 replacement, and sealed against humidity and sea water. The battery compartment, while requiring an isolated compartment, must still be protected from the environment.

### External Interfaces:

Interfaces preferably use an open architecture, to allow for the optimization of performance as well as future upgrade flexibility. External interfaces include sensors interface 109 to the remote unit 10. When remote unit 10 is mounted externally, a built-in sensor is connected to sensors interface 109. If, however, a wider variety of sensors is required, same sensor interface 109, becomes a part of WLAN between remote unit 10 and wireless connected sensors, located anywhere within the container. Remote unit 10 includes GPS receiver 107, GPS receiver 107 transmits status preferably once per minute or less.

Sensor interface 109 within remote unit 10 preferably includes an open and flexible interface to a number of potential sensors, available, either off-the-shelf or custom-made. Status data includes GPS location, sensors status and any other type of data. The data packet size is small preferably of size 256-1000 bits. Sensor interface could be of any possible type including dry contact, serial data (e.g. USB) or parallel data (e.g. printer interface) Any time a new remote unit 10, is activated into the system, an initialization routine allows the installing technician to configure sensor interface 109, according to subscriber requirements. (i.e. technician can define remote unit 10 to sense any type of data. Once the initialization is complete, remote unit 10 commences transmission, in accordance with the initialization routine.

When remote unit 10 is mounted externally on container 111, an antenna may be connected directly to remote unit 10. If, however, the remote unit 10 needs to be mounted internally, teachings of U.S. Pat. No. 6,927,688 may be used for instance to penetrate the container wall to an additional transceiver unit, mounted outside the container wall. Remote unit 10 preferably includes an external transceiver interface to allow for future upgrade-ability to long range wireless connections as alternative to the currently available worldwide satellite networks.

Remote unit 10 is preferably powered by a rechargeable battery 113 of the appropriate size and power rating to last, at a minimum, the longest possible sea voyage, or “parking” situation, e.g. three to four months. Power requirements depend largely on the frequency of status transmissions using long range transceiver 101 and the power consumption of GPS 107 and controller 103. According to embodiments of the present invention, battery power is conserved whenever possible by limiting the long range transmissions to preferably just one member of a cluster of remote units 10. The transmitting remote unit 10 receives status information from all cluster members 10 using short range transceivers 105 with low power requirements. Preliminary calculations show that with a 7AH battery, average remote unit 10 has low power consumption and results in several years usage without battery replacement!!

According to an embodiment of the present invention, integrated remote unit 10 is reusable, and upon loading or unloading of the container, a standard procedure will dictate that remote unit 10 be retested, recharged and reinstalled perhaps even on a different container. Alternatively, if battery 113 lasts for a considerable period, e.g. seven to ten years, remote unit 10 could be attached to container 111 for the lifetime of container 111, without ever needing to remove remote unit 10. Hence, remote unit 10 may become disposable with a very long battery lifetime. At the end of the battery lifetime, corresponding to the lifetime of typical container 111, remote unit 10 attached to container 111 may be thrown away.

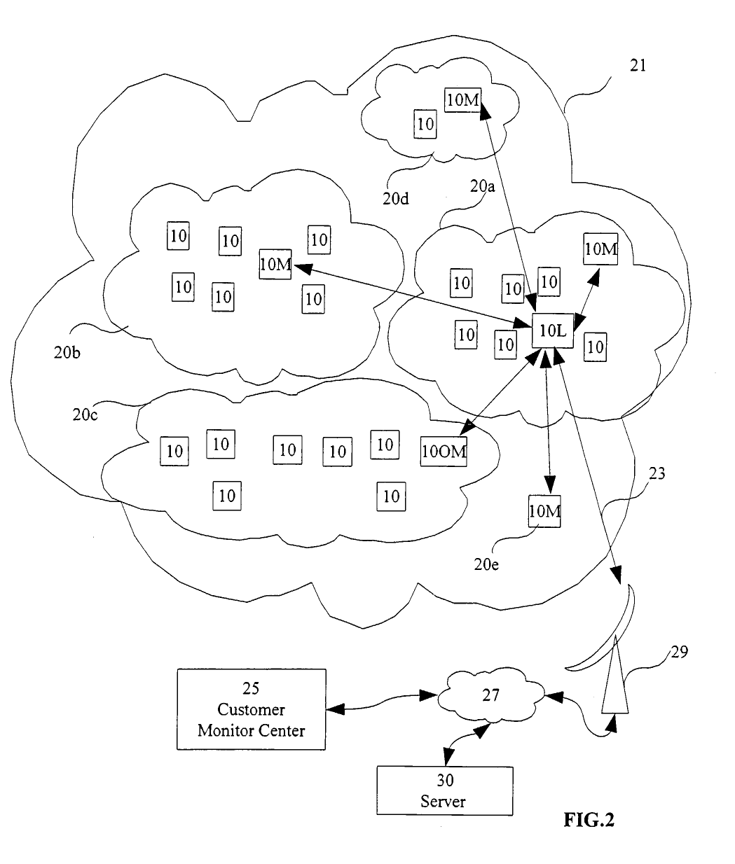

Reference is now made to FIG. 2, which illustrates a single cluster 21 of remote units 10. In the example of FIG. 2, cluster 21 includes four subclusters 20, subcluster 20a includes eight remote units 10, subcluster 20b includes seven remote units 10, subcluster 20c includes eight remote units 10, subcluster 20d includes two remote units 10 and subcluster 20e includes one remote unit 10. At any point in time, one of the remote units 10 in each subcluster 20 acts as a master remote unit 10M. According to an embodiment of the present invention, each remote unit 10 transmits continuously a status signal to master remote unit 10M within sub-cluster 20. An absence of a status signal as received by master remote unit 10M, from any remote unit 10, indicates a potential tamper attempt. Master remote unit 10M transmits an alert signal using short range transceiver 105 to cluster leader 10L. Cluster leader 10L using long range transceiver 101 over an external wireless connection 23, e.g. satellite link to a satellite transceiver 29, transmits an alert to server 30 and the alert is typically reported to the appropriate customer's monitoring center (MC) 25. Two-way communications between remote device 10 using long range transceiver 101 and server 30 and/or monitoring center 25 allow for “back query” from monitor center 25 to remote unit 10 to verify status and reduce false dispatches. Existing low Earth orbit satellite communications infrastructure is typically used to provide communications worldwide to long range transceiver 101. Server 30, monitoring center 25, satellite transceiver 29 are preferably interconnected by data network 27. A typical customer is a shipping company owning several thousand containers 111, trucks and ships. One or more remote devices 10 is installed in each container 111 and vehicle truck and ship. Monitoring center (MC) 25 is connected preferably via virtual private network over data network 27 to server 30. MC 25 is based on a standard personal computer with installed monitoring software, in order to allow customers to monitor their assets, including containers 111 trucks and ships. Monitoring of remote units 10 by human operators at MC 25 is preferably automatic and requires operator interference only when there is an alarm or missing remote unit 10 signal indicating a possible tamper attempt. Typically, each shipping company maintains and pays for securing only its own containers, ships and trucks, via its own operator at dedicated monitoring center 25. Server 30 typically serves multiple monitoring centers 25 and routes respective alarms to appropriate MCs 25. MC 25 can be located in cabin on ship, on a coast Guard base on ship or land, at a ship owner office, cargo owner office. Remote unit 10 data is routed only to an associated MC 25. Any remote unit 10 worldwide on land or on a boat, can be monitored by an authorized MC 25 anywhere in the world. In fact, containers 111, trucks with common attributes but at different locations may be aggregated at any MC 25 and monitored as a group, irrespective of the geographical location of remote units 10.

According to embodiments of the present invention, cluster leader 10L transmits any exception or suspected tamper attempt to server 30 regarding status of remote units 10, and server 30 may query cluster leader 10L or any remote units 10 directly regarding their status in case anything is wrong is suspected. Typically, whenever cluster leader 10L transmits an exception report to server 30, cluster leader 10L sends status back to each of master remote units 10M. Master remote units 10M are “aware” that cluster leader 10L is about to transmit an exception report; if an acknowledgment is forthcoming within a couple of seconds (i.e. if cluster leader 10L is for instance masked, jammed or otherwise tampered with, or if a failure occurred, sub-cluster master remote units 10M select another cluster leader 10L among all cluster members and new cluster leader 10L is expected to “take over” and transmit the exception report to server 30 and/or monitor center 25. New cluster leader 10L selection may be repeated if several cluster members, remote units 10 are masked.

In order to protect against an extreme situation where all cluster members 10 are masked, cluster leader 10L, transmits periodically, e.g. every 25 minutes, a status signal to server 30 and/or monitoring center 25, including status of all cluster members 10. If cluster leader 10L is aware of being jammed, masked or otherwise tampered with, for instance because cluster leader 10L is unable to sense a received signal strength indication (RSSI) from a wireless infrastructure control channel of long range transceiver 101, then cluster leader 10L notifies sub-cluster master remote units 10M, over short range transceiver 105 so that master remote units 10M select a new cluster leader 10L.

Sub-cluster 20e includes a single remote unit 10 which consequently functions as a master remote unit 10M and periodically communicates status to cluster leader 10L. When out of range of any other cluster members 10, single remote unit 10 of sub-cluster 20e, communicates directly with monitor center 25 and/or server 30 using long range transceiver 101. A single remote unit 10 preferably notifies monitor center 25 and/or server 30 when status changes for instance from moving to stationary and vice versa. GPS receiver 107 provides a local indication of motion. Preferably, remote unit 10 as a single member of a cluster 21, will communicate every minute directly with monitoring center 25/server 30 only if stationary. If moving, the transmission is preferably every five minutes, or not at all since tamper attempts on a moving container are very unlikely. Monitoring center 25 and/or server 30 may query the individual remote unit 10 for instance if there an indication of trouble. Preferably, lone remote unit 10 is always attempting to join a cluster 21 to save battery power and reduce communications overhead and when lone remote unit 10 successfully rejoins a cluster 21 will, monitoring center 25 and/or server 30 is notified. Preferably, server 30 receives as part of status report, the state of stored battery power and based on the remaining power server 30 could reduce the rate of periodic queries.

Sub-cluster 20d is a sub-cluster of two remote units 10. Sub-cluster 20d of two member remote units 10 or similarly a cluster 21 of two remote units 10 is common in the case of a “combo”, a truck hauling a container 111 each with a single remote unit 10 installed. When the combo (truck and single container 111) are traveling without any other trucks in the vicinity, then remote units 10 form a cluster of two members. One of the two remote units acts as cluster leader 10L and reports status of both units to server 30. According to an embodiment of the present invention, the driver of the truck has a “panic” button when pushed by the driver, cluster leader 10L alerts server 30. In order to prevent the alert from reaching server 30 both long range transmitters 101 of both cluster members 10 must be simultaneously jammed. Server 30 preferably queries often the status of combo truck/container, e.g. once per minute when the combo is stopped and less often when the combo is moving. Remote unit battery 113 when installed in a truck is preferably chargeable from the truck electrical system. Remote unit 10 installed in truck typically acts as cluster leader 10L in order to save battery power of remote unit 10 installed in the container.

Server 30 preferably authenticates data of status reports as received from cluster leaders 10L before the data becomes available to monitoring center 25. Preferably, the authentication process includes exchanging keys and/or signatures as received from manufacturing without any human involvement minimizing the possibility of the “inside job”, overriding protection by someone familiar with the protection.

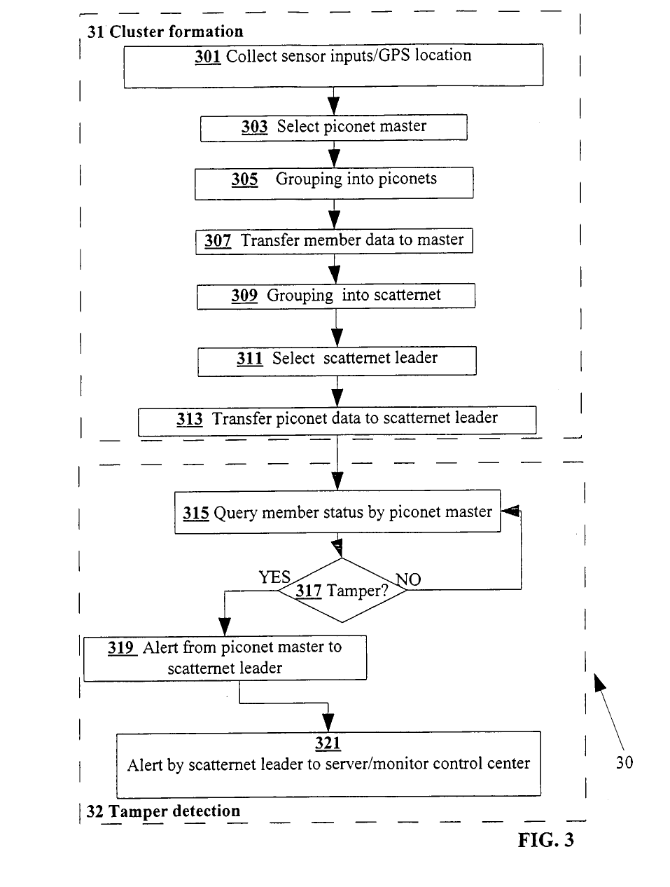

Each remote unit 10 can serve either as an ordinary member of sub-cluster 20 or cluster 21 or a sub-cluster master 10M or a cluster leader 10L at any given moment, depending on the ad-hoc cluster formation algorithm and the relative positions to the other remote unit members 10. Reference is now made to FIG. 3, a flow diagram 30 which illustrates sub-cluster 20 and cluster 21 formation (phase one 31), and querying, breach detection and alerting (phase two 32), according to embodiments of the present invention. In step 301, each remote unit 10 collects data regarding local status from sensor inputs 109 and geographical coordinates from local GPS receiver 107. The data fills a preferably a small, e.g. 30 byte memory buffer. In step 303, a piconet master 10M is selected and in step 305 sub-clusters or piconets 20 (in Bluetooth specification) are formed by remote unit 10 members (or slaves in Bluetooth). In step 307, member data is transfered to piconet master 10M. As the process begins of grouping (step 305) a sub-cluster 20, short range transceiver 105 is set for a very-short range to insure attaching nearest remote units 10. If sub-cluster 20 (a piconet up to 8 members) is formed with the very-short range mode, each remote unit 10 is within about ten meters of sub-cluster (piconet) master 10M. If sub-cluster 20 falls short of eight members, short range transceiver 105 switches to medium-range mode and tries to locate within range other remote unit 10 (piconet) slaves up to the maximum of eight. Preferably, remote unit 10 includes in data buffer, and transmits to other sub-cluster members 10, the current transmission range (mode or power level) Typically remote units 10 within a single piconet 20 belong to a single transmission mode. Since sub-clusters or piconets 20 form and reform themselves continuously, (at every cycle) short range transceivers 105 are continuously switching between transmission modes to ascertain always, that the majority of remote units 10 within the piconet are those nearest to each other. In step 309, piconets 20 are further grouped into cluster 21 (or Bluetooth scatternet 21) and in step 311 a scatternet 21 leader is selected from either one of the master piconet remote units 10M or from among the piconet slaves 10. At this point of process 30, remote units 10 are grouped into piconets 20 each including between one and eight remote units 10, and scatternets 21 including one to ten piconets 20. In step 313, piconet data is relayed to scatternet leader 10L through piconet master remote units 10M.

During each cycle, first cluster formation phase one 31 is described above, second phase 32 includes checking for communication tamper in which every upper hierarchical level, e.g. cluster or scatternet 21 queries lower hierarchical levels sub-cluster or piconet 20 regarding member 10 status. Thus, it is known when a communications tamper attempt is detected and at which hierarchical level the tamper is supected. In step 315, piconet member 10 status is queried by piconet leader 10M. If a tamper attempt is detected, (decision block 317), then an alert is transfered typically to scatternet leader 10L (step 319) and scatternet leader relays (step 321) the alert to server 30 and/or control center 25. Such a hierarchical process is preferred since jamming can occur on a single remote unit 10, a group of units 10, an entire piconet 20 or an whole area with several scatternets 21. Scatternet leader 10L may initiate a periodical status report, every e.g. 25 minutes, by “marking time” on its own clock. Scatternet leader 10L may be re-selected occasionally and so scatternet leader 10L preferably transmits status including local clock to server 30 and/or MC 25. Local (e.g. 25 minute) clock and status is transfered to new scatternet leader 10L when selected.

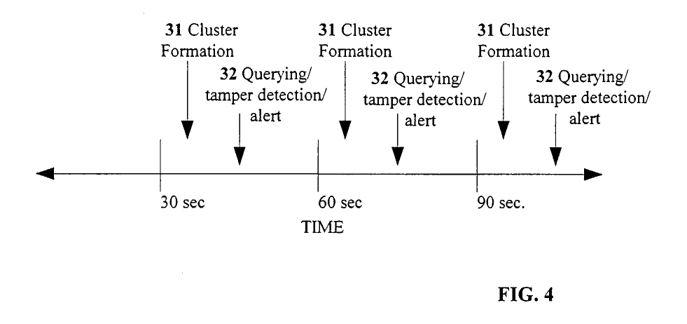

Reference is now made also to FIG. 4 which illustrates a time line for process 30 which includes the two phases: phase one 31 piconet 20/scatternet 21 formation, and phase two 32 querying, tamper detection and alerting when there is a breach or tamper detected. The time dimension is split into cycles of about one minute and each cycle includes both phases 31 and 32 of sub-cluster 20/cluster 21 formation and tamper detection/alerting.

Referring back to FIG. 3, phase one 31 of grouping and formation is discussed in further detail. Piconet formation (step 305) typically begins with a self-proclaimed piconet master 10M. Self proclaimed piconet master 10M is designated as an originating master remote unit 10OM. Originating master 10OM interrogates remote units 10 in its vicinity and picks up the strongest seven remote units 10 and disables them from being further queried by others. These seven remote units 10 plus originating master 10OM form the first piconet 20. Originating master 10OM also picks up the next strongest remote unit 10, beyond the first seven remote units 10, and the next strongest remote unit 10 is defined as the second master remote unit 10M for the next piconet 20. The second master remote unit 10M queries other remote units 10 in its vicinity and picks up the strongest avaiable seven remote units 10, and disables them from being further selected by other master remote units 10M. Second master 10M and the second seven remote units 10 found become the second piconet. The above grouping or formation (step 305) process is repeated until there are no more remote units 10 to be queried. Piconets 20 collectively form scatternet 21.

If remote units 10 are not included in scatternet 21, remote units 10 will form another scatternet 21. Typically any remote unit 10 which does not receive a query within a previously determined period of time, e.g. 36 seconds, will proceed to commence queries for a period of time, e.g. 6 seconds. If remote unit 10 receives acknowledgments from other remote units 10 then remote unit 10 declares itself an originating master 10OM of a new piconet 20. Otherwise, if acknowledgments from other remote units 10 are not received it shall proceed to continue querying for another period of 1 second. If at the end of the additional period of querying, remote unit 10 still does not receive any acknowledgments in response to querying, remote unit 10 declares itself as a “lone” remote unit 10 and selects itself to be leader 10L and sole cluster member 10 and proceeds for instance to transmit status to server 30 every minute.

During the data transfer phase, all master remote units 10M of cluster 21 transfer a list of respective slave remote units 10 to originating master remote unit 10OM along with other data including an identification number identifying master remote unit 10M and received signal strength (RSSI) at long range receiver 101 and battery strength. Originating master remote unit 10OM sorts the RSSI values and typically chooses cluster member 10 with strongest RSSI to be scatternet leader 10L. Other criteria, such as battery strength may be transferred to originating master 10M and used to select scatternet leader 10L as well. Formation phase 31 is now complete with all piconets 20, master remote units 10M including one originating master 10OM, scatternet leader 10L and piconet slave remote units 10 are determined. Querying/Data transfer phase 32 now begins. Each master preferably queries and receives (step 315) data buffers from each of slave remote units 10. Any breach or irregularity at any slave remote unit 10, causes the respective master unit 10M to alert (step 319) originating master 10OM. Originating master 10OM directs scatternet leader 10L to alert (step 321) server 30. Typically, during the second query/data transfer phase 32, originating master 10OM queries all master remote units 10M for a tamper; and if found, (decision block 317) a new cycle proceeds with formation phase 31, ending in an alert transmitted (step 321) by the new scatter leader 10M. If a tamper attempt is not found,(decision block 317) then each master 10M interrogates respective slaves 10 (including scatternet leader 10L for any tamper or breach, and querying master 10 notifies originating master 10OM). Any tamper or breach found are conveyed to scatternet leader 10L by originating master 10OM. At the end of the second querying and data transfer phase 32 all tampers or breaches have been conveyed step (321) to server 30 and/or monitor center 25.

Originating master 10OM once selected in the first cycle of both formation phase 32 and data transfer phase 32 will typically be selected again at the start of the next cycle. However, if master remote unit 10M next in line during the formation phase does not receive acknowledgment from originating master 10OM, then the next in line master remote unit 10M declares itself to be the new originating master 10OM and restarts a new cycle. The new originating master 10OM preferably retains all breaches reported prior to restarting a new cycle so that selected scatternet leader 10L in the new cycle transmits to server 30 any breach occurring prior to the new cycle including a potential tamper of the former originating master 10OM.

A special case occurs if a multiple containers 111 over a reasonable area are being masked (e.g. jammed) simultaneously. In such a case, it is conceivable that all remote unit 10 within the area will conclude falsely that they are lone units 10 and will proceed to transmit individually to server 30 every minute. However, as an acknowledgment is not received from satellite link 23 while remote unit 10 is masked, remote unit 10 will be able to recognize that it is not in lone mode, but a mask or tamper is occurring. Remote unit 10 preferably attempts to communicate with server 30, e.g. three times to reach server 30 if still no acknowledgment is received from satellite link 23, remote unit 10 is still masked Remote unit 10 preferably attempts to transmit to server 30 less often, e.g. every 25 minutes. When the mask is removed remote unit 10 receives an acknowledgment from satellite link 23 and/or adjacent remote unit 10. Typically, previously masked remote unit 10 reports the previous mask as a breach after a new formation. In such a case, if remote unit 10 units were part of an existing scatternet 21 prior to masking, then members 10 of scatternet 21 would have already reported to server 30 about their tampered status. These newly “revived” remote units 10 enable their status to that of remote units 10 waiting to be included in a new formation, triggered by a newly formed originating master 10OM.

In case of sensor malfunction, a command from server 30 and/or monitor center 25 to remote unit 10 disables sensor or alarm input 109 when an alarm reset is unavailable. Similar, a remote command may be used to place remote unit 10 in a power saving mode to conserve battery power, in which only exception reporting takes place even in the case of a lone remote unit 10

### False Alarm Rates:

False alarms may be generated at MC 25 due to the receipt of alert signals at a monitoring center 25 (MC) while, in fact, there is no real alarm or tamper event. This circumstance may cause MC 25 personnel to issue costly dispatches and sometimes even dangerous. There are five potential sources for false alarms in the context of embodiments of the present invention. The sum of all five false alarm sources is the false alarm predicted rate of embodiments of the present invention:

(i) Human error: False alarm rate due to human error is negligible, in embodiments of the present invention, as opposed to home alarm or office alarm systems which are armed and disarmed by owners and prone to owner errors and sensor mishap. Embodiments of the present invention are fully automatic. Typically, only trained technicians interface with systems of the present invention and only upon initial arming and disarming. Typically arming/disarming actions are audited automatically and logged.
(ii) Sensor(s) triggered erroneously at sensor input 109: False alarm rate at sensor input 109 depends to a large extent on the quality of the sensors themselves. Any false alarm randomly occurring at sensor input 109 during formation phase and prior to the querying/data transfer phase will not generally be reported.
(iii) False alarms would occur if remote units 10 in the same scatternet 21 transmit on the same frequency and at the same time. However, remote units 10 within same cluster or scatternet 21 typically use different transmit frequencies, by using frequency-hopping (CDMA-FH) techniques inherent to the cluster network communications protocols, e.g. Bluetooth.
(iv) False alarms due to communications between remote units 10 from different clusters 21 transmitting on the same frequency and at the same time can be eliminated almost entirely. Assuming a maximum of 5 clusters 21 (with up to 80 members each) can occupy an area where any of the members 10 may transmit on the same frequency and at the same time (note each cluster 10 reuses up to 80 frequencies). The probability of no collision is:

$$P = [ 1 - 80 \cdot \{ 1 / 80 \cdot ( {\sum }_{i = 2}^{5} \cdot {C}_{i}^{5} \cdot {p}^{i} \cdot {q}^{5 - i} ) \} ]$$

Given that p=1 milliseconds (burst transmission duration)/60,000 milliseconds, and q=1−p, P=0.999999972, or, one false alarm every 10 years! (Assuming each subscriber transmits every minute. Five clusters 21 were selected since within 100 meters radius—the RF limit of SRT transmitter 105, no more than five clusters 21 (about four hundred containers 111 is contemplated under the worst-case placement of containers 111).
(v) External transmissions by cluster leaders 10L in different clusters 21 transmitting on the same frequency and at the same time is insignificant since cluster leader 10L communicates with server 30 only when there is a significant change to cluster 21.

At 25 kilobits per second, the typical transmission rate of long range receiver 101 a data packet size of 250 bits which requires 10 milliseconds to transmit is transmitted once per minute. The simulated rate of collisions among 110 clusters 21 is about once a day. Each cluster 21 corresponds to up to 80 remote unit members 10, so the total number of remote units 10 in a location with 110 clusters is about 9000 remote units 10. Hence, the worst case false alarm rate is reduced to about one false alarm per day for every 9,000 containers 111 in the same location (e.g. port, a parking lot, a factory. There is no limitation on the number of locations in each of which the false alarm rate is the same. This worst case materializes if we assume every cluster 21 experiences changes every minute, which is an unlikely scenario.

Back-query from server 30 or monitor center 25 to cluster leader 10L may be used to ascertain whether an alarm is false or not. Therefore, the sum of all five types of false alarms is low, well within an acceptable rate of false alarms in the security industry.

RF design of remote unit 10 assumes worst-case situations, and diversity techniques as well as other known RF methods are deployed to mitigate, and, eliminate radio propagation difficulties. Nevertheless, containers 111 on boat or at ports are typically “packed” together so that RF transmission from long range transceiver 101 from deeply stacked container 111 to external wireless link 23 is insufficient to establish communications. Typically, deeply stacked container 111 will not be required to establish long range communications, only short range communications using short range transceiver 105 to another remote unit 10 nearby acting as a sub-cluster master unit 10M. Furthermore, if deeply stacked container 111 is in a lone cluster 21, because of difficulties in RF transmission, deeply stacked container 111 is an unlikely candidate for tampering and intrusion. Hand-held devices may be used by ship crew from time to time to collect breach and or tamper data from units 10 below deck.

According to embodiments of the present invention, a special hand-held unit including both a short-range and long range transceiver may be configured as a hand-held management and control unit by an operator, for instance on ship to ascertain current status of all clusters and sub-clusters. The special unit may be used to determine for instance which remote units are in lone clusters in order to facilitate local correction if required.

According to embodiments of the present invention, geofencing is performed without relying primarily on exception reporting. Geographical coordinates of each remote unit 10 is provided by GPS receiver 107 and transmitted by cluster leader 10L.

Typically, if a container 111 or truck is hijacked, the hijacked remote unit 10 will either have unacceptable geographical coordinates or will be out of range of cluster 21. In either case, an alert status, within a minute or so of the hijacking, is reported by cluster leader 10L to server 30. Hence, geofencing is performed, according to embodiments of the present invention, without requiring extensive communications or logistical complexity.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

While the invention has been described with respect to a limited number of embodiments, it will be appreciated that many variations, modifications and other applications of the invention may be made.

What is claimed is:

1. A system which protects a plurality of mobile entities, wherein the entities include vehicles and containers, the system comprising:
(a) a sub-cluster of remote devices, wherein at least one said remote device is attached to each said entity; wherein each said remote device includes a long range transceiver which communicates with an external wireless connection and a short range transceiver which communicates with other said remote devices of said sub-cluster;
(b) periodically selecting one of said remote devices as a master remote device of the sub-cluster;
wherein said other remote devices continuously transfer data to said master remote device using said short range transceiver.

2. The system, according to claim 1, wherein said master remote device transmits an alert using said long range transceiver upon not receiving said data from at least one said of other remote devices.

3. The system, according to claim 1, wherein said external wireless connection includes a satellite communications connection.

4. The system, according to claim 1, wherein each said remote device further includes an interface to at least one environmental sensor.

5. The system, according to claim 1, wherein each said remote device further includes a global positioning satellite receiver and wherein said data includes geographical coordinates of each said remote unit received by said global positioning satellite receiver.

6. The system, according to claim 1, further comprising
(c) a cluster of remote devices, said cluster including said sub-cluster, wherein said master remote device transmits an alert to one of said remote devices selected as cluster leader of said cluster when said data is not received.

7. The system, according to claim 6, wherein said cluster leader is selected based on a received signal strength of said external wireless connection.

8. The system, according to claim 6, wherein said cluster leader is selected based on battery power availability.

9. The system, according to claim 6, wherein said cluster leader is re-selected periodically at intervals of less than one minute.

10. The system, according to claim 6, wherein solely said cluster leader transmits using said long range transceiver.

11. A method for securing a plurality of mobile entities, wherein the entities include vehicles, and containers, the method comprising the steps of:
(a) attaching a plurality of remote devices respectively to the entities; wherein said remote devices each include a long-range transceiver which communicates with an external wireless connection and a short-range transceiver which communicates with other said remote devices;
(b) grouping of said remote devices into at least one sub-cluster, wherein said grouping includes selecting a master remote device from among said remote devices; and
(c) continuously transferring data from said remote devices to said master remote device using said short range transceiver.

12. The method, according to claim 11, further comprising the step of:
(d) upon not receiving said data from at least one of said remote devices, alerting using said external wireless connection.

13. The method, according to claim 11, wherein said grouping further includes grouping said at least one sub-cluster into at least one cluster, further comprising the step of:
(d) upon not receiving said data from at least one of said remote devices, alerting a cluster leader using said short range transceiver, wherein said cluster leader is selected from among said remote devices.

14. The method, according to claim 13, further comprising the step of:
(e) said cluster leader alerting a control center using said external wireless connection.

15. The method, according to claim 14, further comprising the step of:
(f) back querying by said control center to at least one of said remote devices.

16. The method, according to claim 11, wherein said grouping and said transferring data are performed periodically during an interval of less than one minute.

17. The method, according to claim 11, wherein each said remote device includes a mechanism for adjusting a range of said short-range receiver, wherein said grouping is performed at a shorter range prior to performing said grouping at a longer range.

18. The method, according to claim 11, wherein said transferring data is performed upon query from said master remote device.

19. A method for geofencing a plurality of mobile entities, wherein the entities include vehicles, and containers, the method comprising the steps of:
(a) attaching a plurality of remote devices respectively to the entities; wherein said remote devices each include a long-range transceiver which communicates with an external wireless connection, a short-range transceiver which communicates with other said remote devices and a global positioning satellite receiver which receives local geographical coordinates;
(b) grouping of said remote devices into a cluster, wherein said grouping includes selecting a cluster leader from among said remote devices; and
(c) attempting to transfer data from said remote devices to said cluster leader using said short range transceiver wherein said data includes said geographical coordinates;
(d) alerting by said cluster leader using said long range transceiver based upon selectably either said geographical coordinates or not receiving said data from at least one of said remote devices.

20. A method which protects a plurality of entities, the method comprising the steps of:
(a) attaching a plurality of wireless transceivers to the entities;
(b) periodically selecting a master transceiver from among said wireless transceivers wherein said master transceiver communicates with at least a portion of said wireless transceivers, wherein said portion forms a cluster;
(c) continuously transferring positive status information from each said wireless transceiver of said cluster to said master transceiver; and
whereby a communications tamper on at least one of said wireless transceivers is suspected when said positive status information from at least one of said wireless transceivers is not received by said master transceiver, and
(d) upon not receiving said positive status information from at least one of said wireless transceivers of said cluster, alerting by said master transceiver.

21. The method, according to claim 20, wherein said periodically selecting is based on at least one criterion selected from the group of: (i) an amount of battery power stored in said master transceiver, and (ii) a received single strength to an external wireless connection to said master transceiver.
